(19) United States
(12) Patent Application Publication
(10) Pub. No.: US 2003/0056019 A1
(43) Pub. Date: Mar. 20, 2003

(54) Card terminal and method for operating a card terminal

(76) Inventors: Roger Kehr, Darmstadt (DE); Harald Vogt, Burgau (DE); Joachim Posegga, Bruchsal (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/240,033

(22) PCT Filed: Mar. 16, 2001
(86) PCT No.: PCT/EP01/03055

(30) Foreign Application Priority Data
Mar. 30, 2000 (DE) 100 15 775.0

(51) Int. Cl. G06F 15/163

(52) U.S. Cl. 709/310

(57) ABSTRACT

The invention relates to a card terminal (1) and to a method for operating a card terminal (1) for a card (7) comprising at least one card function (12, 13, 14) and a non-volatile storage (11). According to the invention, the card terminal (1) firstly determines the card function via a device (5) and, according to the card function, a data processing device (2) of the card terminal (1) is subsequently configured with regard to the software.

The present invention is based on a method for operating a card terminal according to the preamble in claim 1 as well as a card terminal having the features set forth in preamble of claim 13. Moreover, the present invention relates to the use of a card having at least one card function and at least one non-volatile data storage device.

A card terminal as well as a method for operating the card terminal are known. Such card terminals have a card reader and a data processing device, the card reader and this device being interconnected. These card terminals are implemented, for example, as automated teller machines which allow a customer to carry out banking transactions using a suitable card. Cards of this type, which are also referred to as smartcards, have at least one card function. In the present case of the automated teller machines, for instance, the cards have a function for receiving cash at these machines. The card has a non-volatile data storage device in which customer-specific data is stored. This data includes, for example, the account number or the like. In most cases, the data is stored on the card in encrypted form so that unwanted access by third parties is at least made more difficult.

To be able to use the card function, a suitable executable or application program is stored in the known card terminal. This program supports the card function, that is, allows it to be executed on the card terminal. Consequently, the known card terminal is limited to a specific card function. Therefore, the known card terminal is not very flexible.

Therefore, the object of the present invention is to provide a method for operating a card terminal as well as a card terminal of the type mentioned at the outset which feature high flexibility.

This objective is achieved in a method for operating a card terminal having the features specified in claim 1. This card terminal is designed for a card which has at least one card function and a non-volatile data storage device. The method according to the present invention has the feature that the card terminal initially identifies the card function and that the card terminal is then configured with regard to the software as a function of the card function. After the card is inserted into the card terminal, initially the card function is identified, as mentioned above, and subsequently, a suitable configuration means is loaded into the card terminal as a function of this card function. Configuration means of that kind can be, for example, so-called “card drivers” which make it possible for the card terminal to communicate with the inserted card. In most cases, these card drivers are needed as configuration means because the data stored in the non-volatile data storage device is not in all cases stored in the same format on different cards. However, configuration means can also be executable or application programs (applications) which support the card function or cause it to be executed on the terminal side. In the method according to the present invention, therefore, the configuration with regard to the software consists in loading at least one configuration means into the card terminal. Thus, the method according to the present invention has the feature that the card terminal is highly flexible because the appropriate configuration means is/are loaded into the card terminal only after the card function has been identified. It is therefore possible to provide card terminals which are identical in terms of hardware for different cards or different card functions. It is only by the inventive configuration with regard to the software that the card terminal is adapted to the corresponding card function, allowing the desired user function to be carried out.

A particularly preferred exemplary embodiment has the feature that a communication connection to a network element which is assignable to the card function is established via a network interface of the card terminal for configuration. This network element can then have stored therein the configuration means which is then loaded via the network into the card terminal where it can then be executed. In a network having a plurality of card terminals, therefore, it is always possible to provide or carry out the desired card function at arbitrary card terminal locations.

Thus, in a refinement of the present invention, provision is made for the network element to transmit at least one configuration means to the card terminal as a function of the identified card function. This configuration means can be a card driver which allows communication between the card terminal or card reader and the card. Thus, in a particularly preferred embodiment, the card terminal can be provided with a “minimum software” which simply allows identification of the card function while the card is inserted. To permit further communication with the card, the card driver will then be loaded.

In a particularly preferred exemplary embodiment, the card function is identified using at least one identifier which is stored on the card. Each card has at least one identifier which is assigned only to this card, it being possible for each identifier to be stored in the non-volatile data storage device as a combination of letters and/or numbers. The at least one identifier can also be stored in encrypted form. To permit identification of the card function, this at least one identifier is read out via the card terminal and at least one card function is identified as a function of the identifier. Thus, provision can be made for the at least one card identifier stored on the card to be designed in such a manner that the card function can be uniquely identified.

To allow the card terminal to be configured with regard to the software accordingly, provision is made in a refinement of the present invention that the card terminal determines from the identifier the network address of the network element. Thus, the identifier can be coded accordingly, providing a clear association with a network address to permit easy identification of and also access to the appropriate network element.

According to a particularly preferred embodiment, provision is made for the card terminal to determine from the identifier query parameters which are routed to the network element to obtain from the network element at least the one configuration means which is assigned to the card function and which will then be executed in the card terminal. If, for instance, a plurality of card functions are stored on the card, or if a single card function requires a plurality of configuration means, then these can be obtained from the network element via suitable request parameters.

According to a further refinement of the present invention, provision is made for the card terminal to establish communication connections to several network elements, preferably one after another, as a function of the card function and/or of the already received configuration means. In this manner, it is possible that, after the identifier has been read out, a network element is determined via which configuration means can be obtained, and that it is then possible to establish a communication connection to another network element to obtain further configuration means.

In an exemplary embodiment, provision is made for at least one of the configuration means to be a configuration program which is also referred to as card driver and which allows the card terminal to communicate with the card.

At least one other of the configuration means can be an executable or application program which makes it possible to carry out or support the card function. These executable programs are also referred to as applications. Thus, the desired card function can be made available at any card terminal of the network.

In another exemplary embodiment, at least one of the configuration means can be a network address of the one network element or of a further network element. After the card function has been identified, for example, the network address of a network element is determined on which several network addresses are stored which are assigned to the corresponding card function. Accordingly, the network address assigned to the card function is selected and transmitted to the card terminal which is then able to access the further network element via this network address to obtain an executable program which is assigned to this card function.

In another exemplary embodiment, provision can be made for at least one of the above mentioned configuration means to be stored on the card. It is then particularly advantageous that, provided that a card driver is stored on the card, a communication between the card terminal and the card is possibly immediately, for example, to then obtain the executable program via a network element. It is also possible for at least one executable program to be stored on the card.

This objective is also achieved by a card terminal having the features recited in claim 13. This card terminal has a card reader and a data processing device in which at least one configuration means can be executed. The card terminal is designed for a card which has at least one card function and a non-volatile data storage device.

The card terminal according to the present invention has the feature that it contains a device for identifying the card function and that the data processing device is designed in such a manner that it can be configured with regard to the software as a function of the card function. This data processing device can therefore have a main memory into which can be loaded at least one configuration means which can then be executed in an arithmetic unit to allow the card function to be executed or supported. Therefore, the card terminal according to the present invention has the feature of being highly flexible. The card terminal is intended, in particular, to carry out the above described method.

To allow the card terminal to be configured with regard to the software, in a refinement of the present invention it contains a network interface which permits establishment of a communication connection to a network element in which at least one of the configuration means is stored.

This objective is also achieved using a card which has at least one card function and at least one data storage device, a card terminal being configured with regard to the software when using the card. The card permits at least access of the card terminal to allow identification of the card function.

At least one configuration means can be stored on the card, that is, in the data storage device. However, it is also sufficient if the identifier which is stored on the card can be read out by a card terminal whereupon the configuration of the card terminal with regard to the software is carried out as a function of this identifier.

It is, of course, possible to store security codes, preferably in encrypted form, on the card which are queried by the card terminal prior to different process steps to prevent unauthorized use of the card.

Further advantageous embodiments follow from the dependent claims.

In the following, the present invention will be explained in greater detail in the light of exemplary embodiments with reference to the drawing.

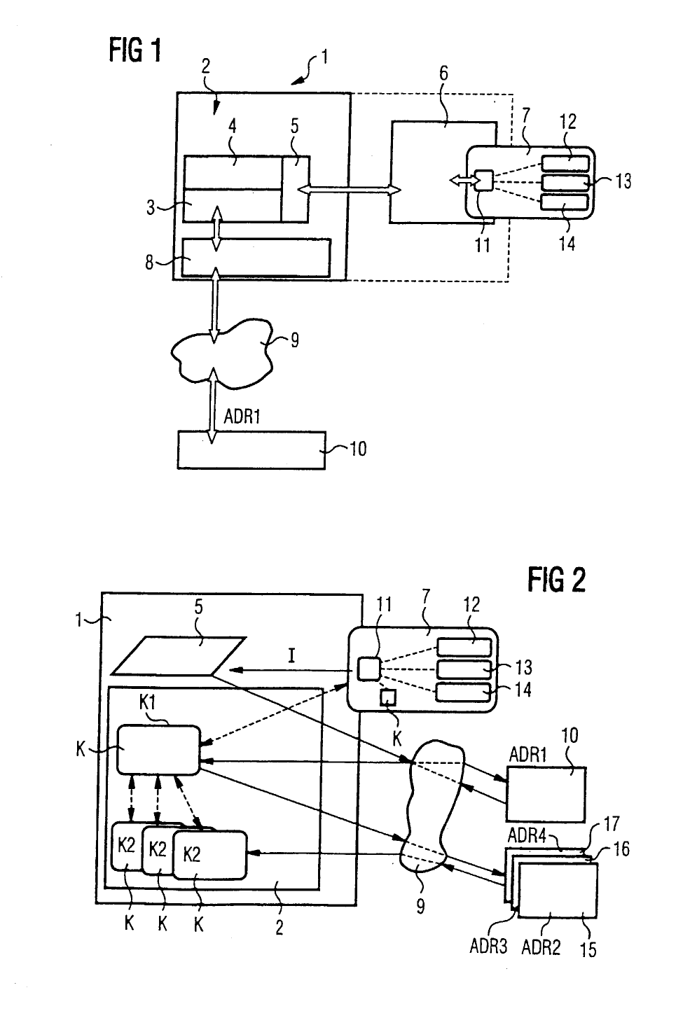

FIG. 1 shows a card terminal;

FIG. 2 depicts a process sequence for the configuration with regard to the software of the card terminal according to FIG. 1; and

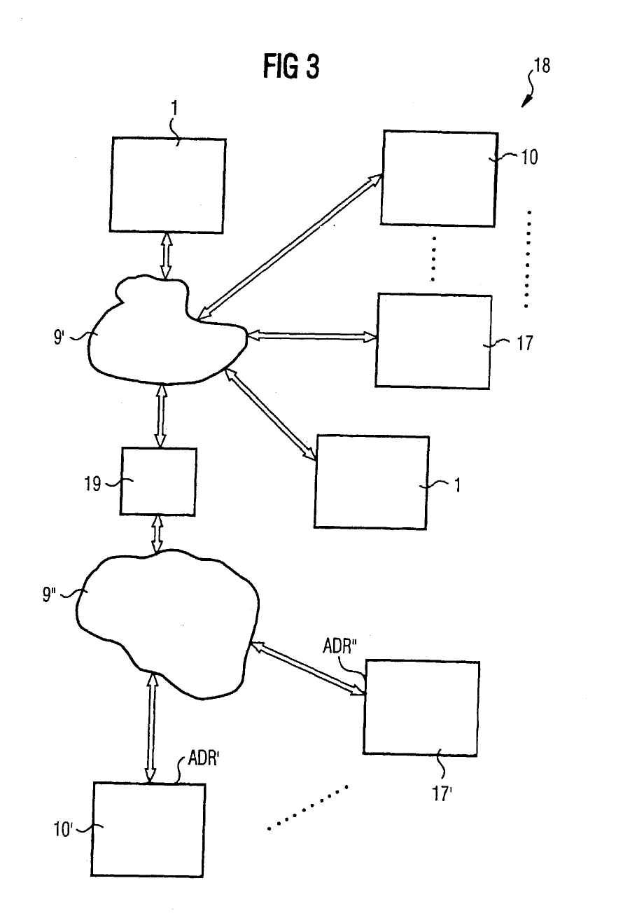

FIG. 3 represents a network including at least one card terminal according to FIG. 1.

FIG. 1 shows a card terminal 1 including a data processing device 2, a main memory 3, an arithmetic unit 4 as well as a device 5 for identifying a card function. Device 2 is connected to a card reader 6 which forms a hardware interface between device 2 and a card 7 which is insertable into card reader 6. Card reader 6 can be implemented as an external device or else be integrated in card terminal I as is indicated in FIG. 1 by a broken line. Moreover, card terminal 1 has a network interface 8 which is connected to device 2 on one side and, on the other side, to a network 9 which can be designed as a local network (LAN) or also as a wide area network, for example, the Internet. Besides card terminal 1, at least one further network element 10 is connected to network 9. Data transmission between network 9 and card terminal 1 and between network 9 and network element 10 can in each case be bidirectional.

Card 7 has a non-volatile data storage device 11 which can be designed as a magnetic strip or, as shown in FIG. 1, as a chip. Card 7 contains at least one card function 12, 13 or 14, the information unit which is associated with card function 12, 13 or 14 being stored as a program code in data storage device 11. In the exemplary embodiment, card 7 contains three card functions; of course, it is possible for card 7 to contain more or less card functions 12, 13, 14. If data storage device 11 is implemented as a chip, this chip can also contain a data processing processor, making it an “intelligent” card 7.

In the following, a method for operating card terminal 1 is described with reference to FIG. 2: After card 7 is inserted into card reader 6, device 5 initially identifies a card function 12, 13 or 14. This is preferably done in that an identifier I, which is stored in data storage device 11 and also referred to as identification string, is read out from card 7. This is carried out, in particular, by resetting the card or data storage device 11 to a defined state whereupon the above mentioned identifier I is supplied by data storage device 11 to device 5. This identifier I, which is also referred to as ATR (Answer To Reset) string, is thus delivered as a result in the course of the standardized resetting process of card 7. Card terminal I maps at least the following information units from this identifier I: network address ADR 1 of network element 10 as well as parameters for a query to this network element 10. Card terminal 1 uses this network address ADR 1 to establish a communication connection to this network element 10 and sends a query to this element 10. This query includes the parameters and information on device 2, for example, to obtain information in a suitable format from network 10. On the basis of this query or this transmitted parameters, a piece of information which is assigned to these parameters is selected from network element 10 and sent back to the card terminal. This information includes at least one configuration means K which is executed in device 2. A configuration means K1 is, for instance, a configuration program which is also referred to as card driver. In device 2, this configuration means K1 is caused to be executed. It then allows communication with card 7. By communication with card 7, device 2 determines at least one further network address ADR2, ADR3 or ADR4 and corresponding query parameters to obtain, from at least one further network element 15, 16, or 17, at least one further configuration means K which can be, for example, an executable program K2. Executable program K2 (application) allows at least one of card functions 12, 13 or 14 to be carried out on the terminal side.

In device 2, which is also referred to as execution platform, configuration means K which have been received from network elements 10, 15, 16, 17 are executed to allow support of the desired card function. Each configuration means K is given access to the communication with the corresponding card function 12, 13 or 14, which is also referred to as application. Moreover, it is possible for each configuration means to obtain access to network interface 8 to be able to independently request further configuration means K via network 9. It is, of course, also possible to allow all configuration means K1 and K2 to be requested from a single network element 10, 17, 16 or 15. However, it would also be conceivable for each configuration means K to be offered by one of network elements 10, 15, 16 or 17, as shown in FIG. 2.

Card terminal 1 has at least one ATR-(Answer To Reset) mapping mechanism which is implemented in device 5. Besides, card terminal 1 is provided with execution platform 2 to be able to execute virtually mobile code, i.e., configuration means K. Therefore, described card terminal 1 can be configured with regard to the software in a versatile manner, in particular, as a consequence of the insertion of card 7 into card reader 6 whereby the appropriate card function 12, 13, or 14 can be identified via device 5. Subsequently, the configuration means K to be executed for the communication with card 7 and the on execution platform 2 can be downloaded via network 9 so that card terminal 1, which is nearly functionless prior to inserting the card, is activated only by the configuration with regard to the software. At the beginning of an activation process, card terminal 1 therefore contains simply a “minimum software” which allows identification of card function 12, 13, or 14. It is only after this card function has been identified and corresponding configuration means have been obtained via network 9 that card terminal 1 is “intelligent” and able to support the at least one card function 12, 13, 14 on the terminal side.

The ATR mapping mechanism to be executed using device 5 could be imagined as the mapping of identifier I to at least one predeterminable network address ADR1, ADR2, ADR3 or ADR4 behind which there is a server which is accessible in network 9 and has this fixed address. The query to this network element 10, 15, 16, 17 could be implemented via an HTTP query which is parameterized by the ATR string and the information of execution platform 2 and in response to which the server returns appropriate configuration means K dynamically, that is, independently.

If a plurality of ATR mapping mechanisms are provided, each mapping mechanism can be assigned at least one identifier I (ATR string) which can be associated with at least one network address ADR, respectively.

Execution platform 2 could, for example, be similar to a Java applet platform of a usual Web browser (Netscape, Internet Explorer, etc.) into which Java applications can be dynamically download and activated. In this context, the essential difference is the possibility of configuration means K to communicate in card terminal 1 with the corresponding card function 12, 13, or 14, or the corresponding card. Other execution platforms are equally conceivable. Information on the execution platform could be used, for example, to supply a driver which is suitable for the execution platform.

Therefore, card terminal 1 can potentially handle all cards for which suitable configuration means K are stored, preferably in network 9, and which are locatable via the ATR mapping mechanism, that is, via identifier I. However, it would also be possible to store at least one configuration means K on card 7.

Because configuration means K are activated on execution platform 2, the execution platform can be able to independently carry out further activities. These include, for example, the identification of applications 12, 13, 14 which are available on the card as well as the initiation of the activation of corresponding configuration means K.

Moreover, configuration means K can offer a service interface in network 9 which is used by other network elements in network 9 to access applications 12, 13, 14 on card 7. However, it would also be conceivable for the configuration means K which are assignable to the corresponding applications 12, 13, 14 on card 7 to operate proactively themselves, that is, to independently carry out further activities and to perform actions which are necessary to enable their range of services. Moreover, it would be possible for these applications 12, 13, 14 to allow the service of card 7 to be provided within a network. This means that applications 12, 13, 14 stored on a card 7 can also be offered via network 9 at other card terminals 1 which are connected to network 9. Thus, it is possible for applications 12, 13 or 14 which are stored on card 7 to constitute the configuration means with regard to the software for at least one further card terminal.

FIG. 3 shows a network 18 including at least two card terminals 1 and at least one network element 10 through 17. These elements are interconnected via a local network 9′. Network 9′ can be connected to a wide area network 9″, preferably the Internet, via a network server 19. Just by way of example, network elements 10′ through 17′ are connected to the Internet 9″ via corresponding addresses ADR′, ADR″. Thus, it becomes clear that for configuring card terminals 1 with regard to the software, it is possible to access configuration means K via network elements 10 through 17 of local network 9′ and/or via network elements 10′ through 17′ of the Internet 9″ to be able to provide the configuration means at at least one of card terminals 2. However, it would also conceivable for at least one card terminal 1 to be connected to the Internet 9″.

1. A method for operating card terminal (1) for a card (7) which has at least one card function (12,13,14) and a non-volatile data storage device (11),
wherein the card terminal (1) initially identifies the card function (12,13,14); and
the card terminal (1) is then configured with regard to the software as a function of the card function (12,13,14).

2. The method as recited in claim 1,
wherein a communication connection to at least one network element (10,15,16,17,10′,15′,16′,17′) which is assignable to the card function (12,13,14) is established via a network interface (8) of the card terminal (1) for configuration.

3. The method as recited in claim 2,
wherein the network element (10,15,16,17,10′,15′,16′,17′) transmits configuration means (K) to the card terminal (1) as a function of the identified card function (12,13,14).

4. The method as recited in one of the preceding claims,
wherein the card function (12,13,14) is identified using at least one identifier (I) which is stored on the card (7).

5. The method as recited in claim 4,
wherein the card terminal (1) determines from the identifier (I) the network address (ADR1, ADR2, ADR3, ADR4, ADR′, ADR″) of the network element (10,15,16,17,10′,15′,16′,17′).

6. The method as recited in one of the preceding claims,
wherein the card terminal (1) determines from the identifier query parameters (I) which are routed to the network element (10,15,16,17,10′,15′,16′,17′) to obtain from the network element at least the one configuration means (K) which is assignable to the card function (12,13,14) and which will then be executed in the card terminal (1).

7. The method as recited in one of the preceding claims,
wherein the card terminal (1) establishes communication connections to several network elements (10,15,16,17,10′,15′,16′,17′), preferably one after another, as a function of the card function (12,13,14) and/or of the configuration means (K).

8. The method as recited in one of the preceding claims,
wherein each of the network elements (10,15,16,17,10′,15′,16′,17′) transmits configuration means (K) to the card terminal (1).

9. The method as recited in one of the preceding claims,
wherein one of the configuration means (K) is a configuration program (K1) which allows the card terminal (1) to communicate with the card (7).

10. The method as recited in one of the preceding claims,
wherein at least one other of the configuration means (K) is an executable program (K2) which makes it possible to carry out the card function (12,13,14).

11. The method as recited in one of the preceding claims,
wherein at least one other of the configuration means (K) is a network address (ADR1,ADR2,ADR3,ADR4,ADR′,ADR″) of a network element (10,15,16,17,10′,15′,16′,17′).

12. The method as recited in one of the preceding claims,
wherein at least one executable program (K2) is stored on the card (7).

13. A card terminal (1) for a card (7) which has at least one card function (12,13,14) and a non-volatile data storage device (11), including a card reader (6) and a data processing device (2),
wherein the card terminal (1) contains a device (5) for identifying the card function (12,13,14); and
the data processing device (2) is designed in such a manner that it can be configured with regard to the software as a function of the card function (12,13,14).

14. The card terminal as recited in claim 13,
characterized by a network interface (8) which permits establishment of a communication connection to a network element (10,15,16,17,10′,15′,16′,17′).

15. The use of a card (7) having at least one card function (12,13,14) and at least one non-volatile data storage device (11) for configuring a card terminal (1) with regard to the software, in particular, according to one of the claims 13 and 14.
